(19) United States
(12) Patent Application Publication
(10) Pub. No.: US 2016/0009050 A1
(43) Pub. Date: Jan. 14, 2016

(54) Concrete Curing Blanket

(71) Applicants: Gary M. Crowel, Fallbrook, CA (US); Randall C. Richards, Riverside, CA (US)

(72) Inventors: Gary M. Crowel, Fallbrook, CA (US); Randall C. Richards, Riverside, CA (US)

(21) Appl. No.: 14/325,929

(22) Filed: Jul. 8, 2014

(51) Int. Cl. B32B 5/00

(52) U.S. Cl. CPC B32B 5/00; B32B 2250/02; B32B 2260/021; B32B 2260/046; B32B 2262/062; B32B 2307/7246

(57) ABSTRACT

Disclosed is a concrete curing blanket that includes an absorbent layer and a vapor barrier thereon, wherein the absorbent layer contains by weight thereof: a first amount of natural cellulose fluffed pulp fiber; a second amount of bicomponent fibers; a third amount of latex; and a fourth amount of superabsorbent fibers.

### BACKGROUND OF THE INVENTION

Concrete is a widely used construction material. In general, concrete is composed of cement, coarse and fine aggregates and chemical additives. “Concrete” describes a mixture of stone, gravel or brushed rock and sand, referred to as “aggregate,” which is bound by a cement. As used herein, “concrete” includes reinforced concrete, concrete that contains organic or silica-based fibers or metallic wire, cable or rods as a reinforcing substance, and polymer-cement concrete that is bound with Portland cement and a polymerized monomer or resin system. Hydraulic concrete and cement are referred to herein as “concrete.” Additional information on the composition and characteristics of concrete may be found in Basic Construction Materials by C. A. Herubin and T. W. Narotta, third edition, Reston Book, Englewood, N.J., which is incorporated herein by reference.

The most common hydraulic cement for construction purposes is Portland cement. Portland cement is a heat-treated mixture primarily of calcium carbonate-rich material, such as limestone, marl or chalk, and material that is rich in Al₂SiO₂, such as clay or shale. Portland cement comes in several varieties that are distinguished by such characteristics as the rate of acquiring strength during curing, the amount of heat of hydration generated, and resistance to sulfate attack. Other types of hydraulic cements include aluminous cement, chalcedony cement, which is made from amorphous quartz, and Roman cement, which combines burnt clay or volcanic ash with lime and sand.

Concrete is mixed with water to form a thick slurry, poured into place, typically within forms that contain expansion of the slurry, finished and then cured. Curing involves chemical changes that result in setting and hardening. These chemical changes occur over a considerable period of time in the presence of water. Hydration is important in the curing of hydraulic concretes, i.e., concretes that are dependent on a hydration reaction for hardening, and concretes that are bound with hydraulic concretes. Ideally, concrete should be kept wet after it has set for as long a period as is practicable. This period generally ranges from 7 to 21 days.

Producing quality hydraulic concrete or cement requires proper curing. Curing increases concrete strength, hence structural value. Proper curing is necessary for producing water-tight, durable concrete.

Concrete strength and water-resistance improves when the cement is thoroughly hydrated during curing. Proper curing slows the loss of moisture from concrete and reduces early carbonation of the surface. Excessive evaporation and drying or otherwise poor curing of concrete inhibits hydration. If drying is excessive, light traffic on a concrete surface may result in dusting. Inadequate curing also may cause “craze cracking” or “crazing.”

A concrete floor dusts under traffic because the wearing surface is weak. This weakness can be caused by the finishing operation performed over bleed water on the surface. Finishing or working this bleed water back into the top of the slab produces a low strength layer right at the surface. Placement of concrete over poly or some non absorbent surface, increases bleeding and as a result the risk of surface dusting.

“Crazing” or “map cracking” is a pattern of random fine cracks that occur at the surface of concrete at an early age when the unhardened surface mortar dries out faster than the concrete below. This drying at the surface causes the concrete at the surface to shrink at a faster rate than the concrete below causing stresses at the surface resulting in the fine “map crack” pattern. Since these cracks occur at the surface only, they become an unpleasant sight but are none-the-less harmless structurally and will not cause durability problems. Crazing may be more evident when slabs are constructed in hot, windy, and dry installation conditions.

Maintaining an optimal amount of water in contact with curing concrete optimizes the strength and durability of the concrete. For example, if concrete is kept wet for the first ten days after setting, strength and durability thereof increase 75 percent over ordinary aging at dry surface conditions. As reported by Ken Hover in Curing and Hydration: Two Half Truths Don't Make a Whole, published in the summer 2002 edition of the Concrete News by L & M Construction Chronicles, the more water that is made available to the concrete during curing, the better.

To keep concrete hydrated, the concrete industry has come to rely on concrete curing blankets for covering wetted concrete and extending the duration of damp conditions on the curing surface thereof. Some concrete curing blankets have included burlap and cotton mats, wet rugs, moist earth or sand, sawdust and other coverings likely to act as a moisture barrier. Burlap-based blankets pose many problems, including hydrophillic greasiness; large voids that promote non-uniform concrete surface wetting; stiffness and non-resiliency that prevents conformity to surface irregularities; and fibers that snag on concrete surfaces, which may lead to undesired markings. Cotton mats tend to disintegrate well before the desired curing duration, leaving clumps of material stuck on the surface requiring refinishing. Some concrete curing blankets also have included moisture barriers, such as water-proof papers and plastic films. While films may help reduce evaporation, they do not cure problems associated with underlying absorbent layer.

As used herein, “airlaid” refers to a fibrous structure formed primarily by a process involving deposition of air-entrained fibers onto a mat, typically with binder fibers, and typically followed by densification and thermal bonding. In addition to traditional thermally bonded airlaid structures, those formed with non-tacky binder material and substantial thermally bonded, “airlaid,” according to the present invention, also includes co-form, which is produced by combining air-entrained dry, dispersed cellulosic fibers with meltblown synthetic polymer fibers while the polymer fibers are still tacky.

“Airlaid” also includes an airformed web to which binder material is added subsequently. Binder may be added to an airformed web in liquid form, e.g., an aqueous solution or a melt, by spray nozzles, direction injection or impregnation, vacuum drawing, foam impregnation, and so forth. Solid binder particles also may be added by mechanical or pneumatic means.

As used herein, “Superabsorbent polymers” (“SAP”) refers to polymers that can absorb and retain extremely large amounts of a liquid relative to their own mass. Water absorbing SAP, classified as hydrogels, when cross-linked, absorb aqueous solutions through hydrogen bonding with water molecules. A SAP's ability to absorb water is a factor of the ionic concentration of the aqueous solution. In deionized and distilled water, a SAP may absorb 500 times its weight (from 30-60 times its own volume) and can become up to 99.9% liquid, but when put into a 0.9% saline solution, the absorbency drops to maybe 50 times its weight.

The total absorbency and swelling capacity are controlled by the type and degree of cross-linkers used to make the gel. Low density cross-linked SAP generally have a higher absorbent capacity and swell to a larger degree. These types of SAPs also have a softer and more sticky gel formation. High cross-link density polymers exhibit lower absorbent capacity and swell, but the gel strength is firmer and can maintain particle shape even under modest pressure.

SAPs commonly are made from the polymerization of acrylic acid blended with sodium hydroxide in the presence of an initiator to form a poly-acrylic acid sodium salt, sometimes referred to as sodium polyacrylate. Other materials also used to make SAPs include, but are not limited to: polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile.

As used herein, “superabsorbent fibers” (“SAF”) are white, odorless and have the appearance and improved handling characteristics of textile fibers, while offering the possibility of being used to produce a wide range of fabrics. SAF are made from crosslinked polymerization of sodium acrylate, acrylic acid and methyl acrylate. SAF provide extremely high rates of saline and water uptake. SAF also add strength as a fibril element rather than a particle.

While effective for their intended purposes, thermally- and latex-bonded curing blankets are costly to manufacture from equipment and materials perspectives. Latex-bonded materials also may not be hydrophobic, which would lead to blanket layer breakdown well before the prescribed duration for curing concrete.

Yet another issue with concrete curing blankets, especially single-use blankets employed in large, commercial construction projects, is that they can create a great deal of waste. Since many curing blankets are constructed of synthetic materials, they do not breakdown, clogging landfills for countless years.

What is needed is a durable concrete curing blanket that promotes distribution of available water over a curing concrete surface, discourages evaporation and is recyclable.

### SUMMARY OF THE INVENTION

The invention is a concrete curing blanket that promotes distribution of available water over a curing concrete surface, discourages evaporation and is recyclable. Accordingly, an embodiment of a concrete curing blanket constructed according to the principles of the invention includes an absorbent layer and a vapor barrier thereon, wherein the absorbent layer contains by weight thereof: a first amount of natural cellulose fluffed pulp fiber; a second amount of bicomponent fibers; a third amount of latex; and a fourth amount of superabsorbent fibers. Another embodiment of a concrete curing blanket constructed according to the principles of the invention substitutes superabsorbent polymers for the superabsorbent fibers.

The invention provides improved elements and arrangements thereof, for the purposes described, which are inexpensive, dependable and effective in accomplishing intended purposes of the invention. Other features and advantages of the present invention will become apparent from the following description of the preferred embodiments which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a vertical cross-sectional detail view of an embodiment of a curing blanket constructed according to principles of the invention; and

FIG. 2 is an environmental perspective view of the embodiment of FIG. 1.

### DETAILED DESCRIPTION OF THE PREFERRED EMBODIMENTS

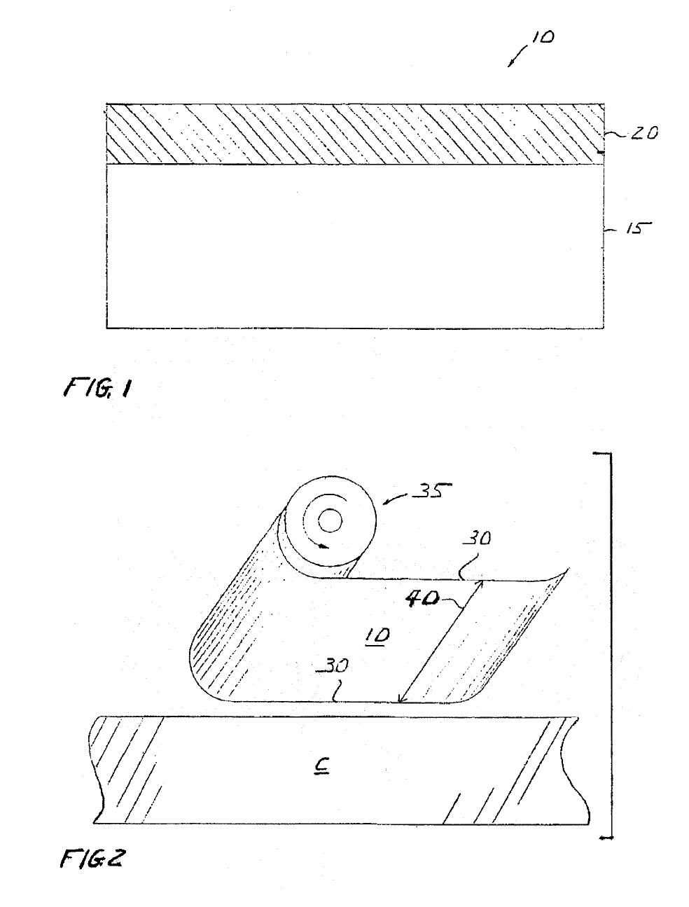

Referring to FIG. 1, an embodiment of a concrete curing blanket 10 constructed according to principles of the invention has an absorbent layer 15 disposed on an impervious layer 20. If sufficiently saturated, concrete curing blanket 10 maintains the optimal amount of water in contact with an entire surface of curing concrete, which optimizes the strength and durability of the concrete when cured.

Preferably, absorbent layer 15 is airlaid, as described above. Because airlaid hydrogen bonded materials tend to disintegrate with prolonged exposure to water, airlaid natural fiber mats have not been considered optimal for concrete curing. The invention overcomes this problem and maintains integrity of the absorbent layer by incorporating natural cellulose material with bi-component fibers in the resultant airlaid structure. Latex also enhances inter-fibril cohesion.

Absorbent layer 15 contains bi-component fibers, fluff pulp, latex, super absorbent fibers and/or super absorbent particles. Bi-component fibers are coaxial fibers having an inner component with a higher melting temperature than an encasing outer component. When heated, the outer component melts for bonding with other elements, while the inner component does not melt, thus lending integrity and strength to the bonded material. The inner and outer components may be selected from polypropylene, polyethylene or other compositions and in proportions suitable for the purposes described, particularly providing sufficient inter-fibril cohesion to maintain integrity of absorbent layer 15.

Absorbent layer 15 includes as much natural cellulose fluffed pulp fiber as possible without sacrificing integrity of absorbent layer 15. The amount of natural cellulose fluffed pulp fiber depends on the efficacy and amount of bi-component fibers and latex needed to maintain integrity of absorbent layer 15. Preferably, absorbent layer 15 contains 50-95%, preferably 80%, natural cellulose fluffed pulp fiber.

The fluff pulp, preferably, is derived from southern softwood, northern softwood, southern hardwood, northern hardwood, kanaf or eucalyptus fibers. These materials provide short fibers that offer great surface area for trapping and absorbing water. The fibers derived from protein based, cotton, agave, plant stalk (bast) fibers of other mats tend to be much longer, hence afford less surface area for trapping and absorbing water. These longer fibers also have waxes, resins and some lignin present that discourage entrapping water. These longer fibers are less absorbent and exhibit geometries that are not as favorable as the present cellulose from soft and/or hardwood fibers. Further, the pulp fibers of the present invention also tend to provide greater tensile strength than the fibers of other mats.

The fluff pulp of absorbent layer 15 may be, but is not limited to being obtained from a Kraft process, rather than mechanical pulping. Mechanical pulping does not produce a clean product, free of the waxes, resins, silicone, turpentine that are present in the virgin materials recited above. Bleached Kraft pulp provides optimal absorption capabilities by producing clean cellulose. The Kraft process produces a bulkier cellulose with a white absorptive component that prevents discoloration of a concrete surface in contact therewith. Discoloration commonly occurred with burlap materials.

The latex bonding agent is sprayed on natural fibers or part of the bi-component fibers and aids in strengthening adhesion among the bi-component fibers and other materials in absorbent layer 15. As discussed above, the amount of latex depends on the proportions of fluff pulp and bi-component fibers as needed to provide sufficient integrity of absorbent layer 15. The latex binders may contribute as much as 5-35%, preferably 5%, by weight.

The amount of SAF and/or SAP in absorbent layer 15 depends on the amount of fluff pulp in absorbent layer 15. Since SAF/SAP retain more hydration than fluff pulp, assuming consistent performance, that is the provision of available hydration for curing concrete, then adding or increasing the amount of SAF/SAP will permit elimination of a greater amount of fluff pulp until the fluff pulp is eliminated entirely. However, eliminating less fluff pulp than needed to offset the added SAF/SAP for maintaining consistent performance would yield an absorbent layer 15 having greater performance characteristics. Absorbent layer includes at least 3%, and preferably 5% SAF by weight of the absorbent layer.

In sum, a preferred embodiment of absorbent layer 15 contains by weight 80% fluff pulp, 10% bi-component fibers, 5% latex and 5% SAF and/or SAP.

Referring also to FIG. 2, the unique composition of concrete curing blanket 10 enables it to wick moisture from oversaturated areas to dry areas. As edges 30 of concrete curing blanket 10 dry, concrete curing blanket 10 wicks moisture from more hydrated areas to edges 30 and vice versa. Concrete curing blanket equalizes the moisture saturation level therethrough.

Preferably, impervious layer 20 is a vapor barrier. To this end, impervious layer 20 may include an extruded or coated polyethylene or polymer latex material or film as a vapor-impervious backing.

Absorbent layer 15 and impervious layer 20 may be thermally bonded in a basis weight ranging from 40 to 500, preferably 80 to 175, grams per square meter (gsm). Ideally, the latex material is a two-part manufactured composition that renders it insoluble in water. The water insolubility discourages disintegration of concrete curing blanket 10 or, more specifically, absorbent layer 15, which would lead to imperfections in the finished surface of a concrete slab.

One part of the latex composition is a high-viscosity polymer filler agent, while the other part is a water resistant agent obtained by polymerization. A binder dispersed in water forms films by fusion of the plastic filler particles as the water evaporates during manufacturing or curing.

Absorbent layer 15 and impervious layer 20 may be bonded with a special water resistant adhesive having a soft point of 210° F.

Impervious layer 20 preferably is opaque, with or without coloration, but preferably white. This allows for ready visual perception of water in concrete curing blanket 10 and on a slab surface, which realizes for owners and contractors tremendous labor savings in tending the curing slab and blanket to ensure that adequate water is present on all portions of a slab to be cured. When blanket is fully hydrated, the blanket presents a grey appearance; unsaturated areas appear white. Workers readily may see unsaturated “white” areas and take steps to eliminate bubbles or correct other non-uniformities with respect to contact between concrete curing blanket 10 to the surface of a curing concrete slab, or moisture provided thereby.

A target caliper or thickness for concrete curing blanket 10 is 2.0-10.0 mm. A target tensile strength for concrete curing blanket 10 is 3,700-5,000 psi. A target absorbency for concrete curing blanket 10 is 15.0-20.0 g/g, preferably 18.5 g/g.

In practice, a method of curing concrete according to principles of the invention includes wetting target curing concrete surface C and disposing concrete curing blanket 10 on target curing concrete surface C with absorbent layer 15 nearest thereto. The method preferably includes re-wetting edges of concrete curing blanket 10 so that water wicks to all areas of concrete curing blanket 10. The method also includes removing concrete curing blanket 10 from target curing concrete surface C after target curing concrete surface C is cured.

In practice, a manufacturer ships rolls 35 of concrete curing blanket 10 on pallets (not shown) to a site where concrete is to be poured. On each roll 35, concrete curing blanket 10 has a width 40 defined by edges 30. Each pallet contains approximately sixteen rolls 35 that provide approximately 800 to 1,600 square feet of coverage per roll. Each roll 35 is encased and protected with shrink wrap (not shown) to minimize exposure to contamination until concrete curing blanket 10 is applied to target curing concrete surface C during the wet cure process. The shrink wrapping allows concrete curing blanket 10 to be stored outside during construction.

After removing the protective shrink wrap (not shown), concrete workers slowly roll concrete curing blanket 10 onto target curing concrete surface C. Properly aligning and rolling concrete curing blanket 10 reduces the possibility of forming wrinkles in concrete curing blanket 10 or trapping air thereunder.

Once disposed on target curing concrete surface C, concrete curing blanket 10 becomes saturated with water and increases in weight dramatically. The weight increase allows for rolling out multiple adjacent lengths of concrete curing blanket 10, preferably with an overlap of two to four inches, without having to lap, tape, weigh down or otherwise restrain adjacent edges 30 to maintain uniform, void-free coverage of target curing concrete surface C. Since the airlaid structure of concrete curing blanket 10 is so absorptive and takes longer to dry out, moisture, hence weight, dissipate slower, further eliminating the need to restrain edges 30.

For best results, water should be allowed to pond in front of roll 35 as it is rolled along target curing concrete surface C.

In the unlikely event a wrinkle (not shown) occurs in concrete curing blanket 10 during application, the method may include eliminating a wrinkle in concrete curing blanket 10. A portion of concrete curing blanket 10 may be removed by cutting concrete curing blanket 10 across width 40 of the affected area with scissors. Three- to four-foot sections on each side of the wrinkled area are peeled away then reapplied to target curing concrete surface C by gently, simultaneously stretching and lowering the sections back onto the wet cure surface.

Because concrete curing blanket 10 absorbs and retains significant amounts of water, concrete curing blanket 10 adheres to target curing concrete surface C like no other concrete curing blanket and insures a more complete, uniform wet cure and surface appearance that other concrete curing blankets.

The invention is not limited to the particular embodiments described herein, rather only to the following claims.

I claim:

1. Concrete curing blanket comprising:
an absorbent layer; and
a vapor barrier on said absorbent layer;
wherein said absorbent layer comprises by weight thereof:
a first amount of natural cellulose fluffed pulp fiber;
a second amount of bicomponent fibers;
a third amount of latex; and
a fourth amount of superabsorbent fibers.

2. Concrete curing blanket of claim 1, wherein said absorbent layer is airlaid.

3. Concrete curing blanket of claim 1, wherein said absorbent layer and said vapor barrier are thermally bonded.

4. Concrete curing blanket of claim 1, wherein the second amount, the third amount or combinations thereof are sufficient to maintain integrity of said absorbent layer.

5. Concrete curing blanket of claim 4, wherein the first amount equals 100% less the second amount, the third amount and the fourth amount.

6. Concrete curing blanket of claim 1, wherein the first amount is 60-95%.

7. Concrete curing blanket of claim 1, wherein the first amount and the second amount is 85%.

8. Concrete curing blanket of claim 1, wherein the third amount is at least 3%.

9. Concrete curing blanket of claim 1, wherein the fourth amount is at least 3%.

10. Concrete curing blanket of claim 1, wherein said vapor barrier is opaque.

11. Concrete curing blanket comprising:
an absorbent layer; and
a vapor barrier on said absorbent layer;
wherein said absorbent layer comprises by weight thereof:
a first amount of natural cellulose fluffed pulp fiber;
a second amount of bicomponent fibers;
a third amount of latex; and
a fourth amount of superabsorbent polymers.

12. Concrete curing blanket of claim 11, wherein said absorbent layer is airlaid.

13. Concrete curing blanket of claim 11, wherein said absorbent layer and said vapor barrier are thermally bonded.

14. Concrete curing blanket of claim 11, wherein the second amount, the third amount or combinations thereof are sufficient to maintain integrity of said absorbent layer.

15. Concrete curing blanket of claim 14, wherein the first amount equals 100% less the second amount, the third amount and the fourth amount.

16. Concrete curing blanket of claim 11, wherein the first amount is 60-95%.

17. Concrete curing blanket of claim 11, wherein the first amount and the second amount is 85%.

18. Concrete curing blanket of claim 11, wherein the third amount is at least 3%.

19. Concrete curing blanket of claim 11, wherein the fourth amount is at least 3%.

20. Concrete curing blanket of claim 11, wherein said vapor barrier is opaque.
